(19) United States
(12) Patent Application Publication
(10) Pub. No.: US 2012/0117164 A1
(43) Pub. Date: May 10, 2012

(54) Method and Software of NetBout

(75) Inventor: Yegor Bugayenko, Naples, FL (US)

(73) Assignee: Yegor Bugayenko, Naples, FL (US)

(21) Appl. No.: 12/943,022

(22) Filed: Nov. 10, 2010

(51) Int. Cl. G06F 15/16

(52) U.S. Cl. 709/206

(57) ABSTRACT

NetBout is an alternative method of online communication that replaces or stays on top of e-mails, instant messaging, audio and video conferences, tracking systems, shared documents, and social networks. NetBout is an isolated persistent communication environment providing persistency, isolation, anonymity and usability for its participants.

### BACKGROUND

1. Field of Invention

The present invention generally relates to online computer-mediated communication mechanisms.

2. Prior Art

Computer-mediated communication (CMC) is a critical element of business and social life nowadays [? ? ]. CMC overcomes physical and social limitations of other forms of communication, and therefore allows the interaction between people who are not physically sharing the same space. Existing forms of CMC include e-mail [? ], instant messages [? ? ], bulletin boards, ticket management systems [? ? ? ], videos, audio or text conferences, shared documents, social network sites (SNS) [? ], blogs [? ], and massively multiplayer online (MMO) games. All of these forms have drawbacks, but the four most critical are lack of persistency, lack of isolation, lack of anonymity, and lack of usability.

“Lack of persistency” is what e-mail, instant messages, and conferences suffer from since they are not designed as long-term holders of conversation protocols.

“Lack of isolation” makes social networking systems impossible to use for private conversations. They are designed as “all or nothing” online publishing boards where users either share their information to some limited audience (called “friends”), or keep it private.

“Lack of anonymity” is a root source of unsolicited messages delivered by e-mail and via instant messaging systems. SMTP [? ] protocol was not designed with privacy in mind. Being aware of an e-mail address anybody can delivery any message to the recipient. There are similar privacy and security concerns related to SNS [? ], blogs [? ] and MMO [? ].

“Lack of usability” is what makes ticket management systems difficult to use for a public audience. The installation and configuration of Bugzilla [? ], Trac [? ], and similar products require certain experience and resources. And, the usage of them is a complex task for a non-skilled computer user.

There is a strong necessity to invent and design a system that will overcome said drawbacks and enable persistent, isolated, private, and easy-to-use CMC.

### SUMMARY

The invented “Method and Software of NetBout” enables much more privacy and flexibility in CMC than any other existing mechanisms.

NetBout is an isolated persistent online conversation between parties (both people and computers). A NetBout is started by a participant who has the ability to invite others and remove them when necessary. Every participant can send messages to the NetBout, making them visible to others.

NetBout solves the problems which other communication mechanisms (like e-mail, SNS, and conferences) suffer from related to their lack of persistency, isolation, privacy, and usability.

Every NetBout is persistent for a lifetime. Its participants do not need to archive, protocol, or log anything manually.

Every NetBout is isolated and is visible only to its participants. NetBout resembles a private dedicated room for a single conversation. Even if the same participants establish another conversation on some other subject it is another “room” and another NetBout isolated from all others.

NetBout does not reveal any private details of its participants. It does not enable any of its participants to send unsolicited messages to each other outside of the established and accepted conversation.

NetBout is an easy-to-use online entity, which is created, archived, tagged, read, and understood in seconds for a non-computer user.

### SHORT DESCRIPTION OF DRAWINGS

FIG. 1 is a demonstration of main workflow between NetBout and its participants.

FIG. 2 is a simplified demonstration of components integration in NetBout software system.

FIG. 3 is a visual demonstration of isolation principle behind every NetBout.

FIG. 4 contains a workflow diagram explaining integration of helpers into NetBout.

FIG. 5 contains a workflow diagram explaining how Application Programming Interface enables automated integration of NetBout and other computer systems.

FIG. 6 contains a screenshot of NetBout software main web page.

### DETAILED DESCRIPTION OF DRAWINGS

While this invention is susceptible to be embodied in many different forms, a specific embodiment is shown in the drawing and will be described herein in detail. The present disclosure is to be considered as an exemplification of the principles of the invention and is not intended to limit the invention to the specific embodiments illustrated.

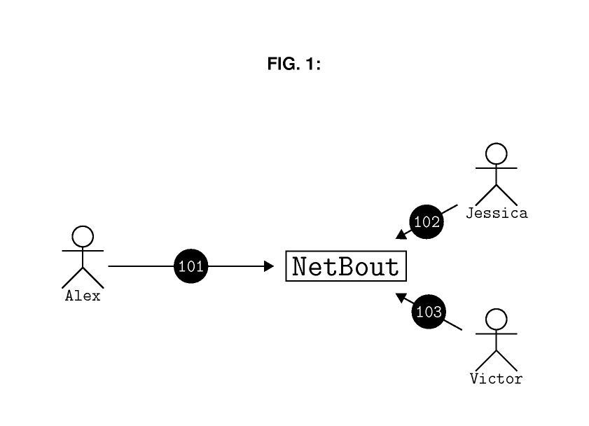

NetBout is a dedicated virtual environment for a conversation between parties, as visually explained in FIG. 1. Alex, as an initiation of the conversation, creates a new NetBout, at 101. He invites Jessica and Victor to join him, and they accept his invitation. Once the invitation is accepted, they start talking in the NetBout the same way they talk in online chats, instant messaging systems or online forums, via 102 and 103.

The conversation is asynchronous, meaning that every participant sends a message to NetBout without getting an immediate answer. Instead, the message gets posted in NetBout and becomes visible for all other participants. There is where NetBout resembles a bulletin board system or online chat. Messages are posted in a chronological order and are visible to all participants just like messages in an online blog or forum message, with the most recent on top (or on the bottom). Every message has a number of attributes attached to it and is visible to readers, including (but not limited to): date and time of publication, name and photo of the author, priority if set by the author, and may be some others as necessary.

Contrary to e-mails, video conferences, and phone calls, NetBout has an endless life cycle. It is absolutely persistent, meaning that its participants may get back to the conversation any time and the conversation will stay online. The persistence of a NetBout does not depend on the willingness of its participants. None of them can cancel a NetBout, thus making it invisible to others. Once a NetBout is started and its participants have accepted an invitation to join, nobody can destroy the NetBout and remove it from a participant's account. Such a strict persistence management mechanism distinguishes NetBout from forums, bulletin board systems, and almost all other communication means, where in most cases an initiator of a conversation controls its persistency.

NetBout is n securely isolated communication environment for its users, where they exchange information messages without any fear of their disclosure to anyone else. Access to NetBout messages is protected by user name and password, and can't be shared with anyone except its owner.

Unlike e-mails, instant messages, phones and other peer-to-peer communication means, NetBout does not disclose contact details to conversation participants. The only public element is the unique ID of a registered user, for example netbout.com/alex. In this example alex is a unique ID of a user, which can be disclosed to anyone. Knowing this ID does not mean that a new conversation can be established with this user. However it is possible to send an invitation to this user. Once the invitation is accepted, a new NetBout conversation may be established. In other words, users are hidden behind their NetBout IDs, without any fear to be accidentally or intentionally contacted by an unwanted party.

The NetBout online conversation environment is web hosted and does not require any software installation or configuration, unlike web conferences or instant messaging systems. Moreover, the initialization and closure of a NetBout is done in seconds, with a simple web click to the link or a bookmark in a web browser. NetBout is very similar to a “blog” page, where users post their comments and read replies from other users. The page can be opened very quickly and does not require any software configuration or installation.

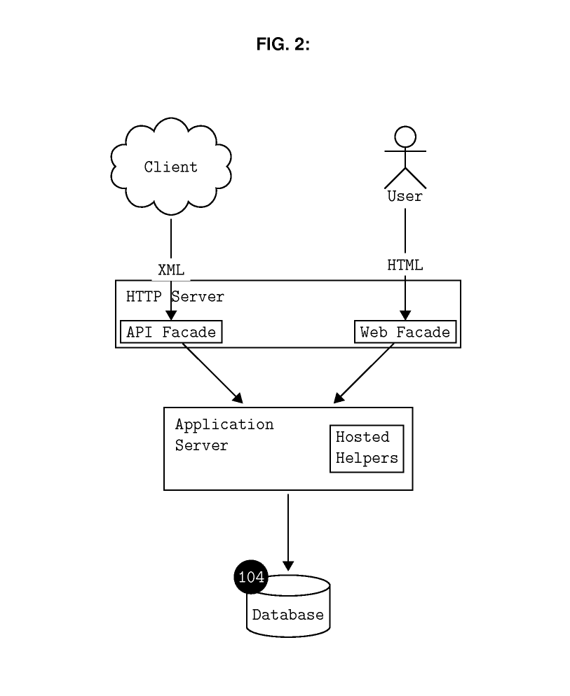

FIG. 2 explains the integration of software components that altogether implement a NetBout. A User communicates with a Web Facade of the system via an HTTP interface, using HTML markup language. In other words, web pages are rendered to the User's web browser in HTML. Web Facade translates the User's requests into application specific object-oriented calls, passed to the Application Server.

The Application Server retrieves a persistently stored NetBout from the Database 104. When necessary, Application Server utilize a number of Helpers, provided by third-parties, in order to give extra functionality to the User, a NetBout participant.

The HTML page created by the Application Server is delivered by Web Facade to the User's web browser.

A very similar process happens when a computerized client is acting on behalf of a User, through XML interface. API Facade, being part of a HTTP Server, converts its request into object-oriented calls, understandable by the Application Server. Then, the exact same mechanism takes place as with Web Facade. The NetBout's state is retrieved from the Database 104 and returned back to the Client in XML format.

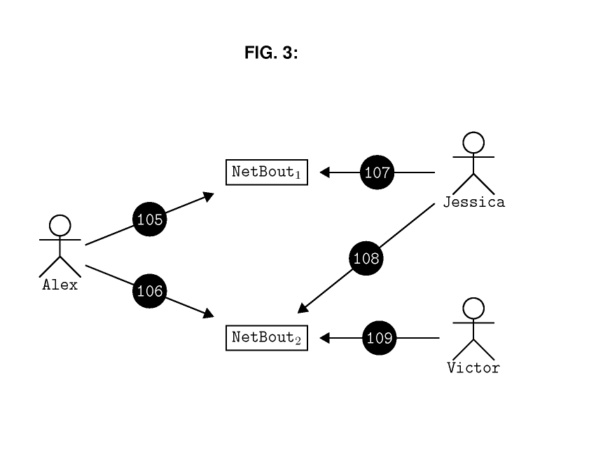

FIG. 3 shows that every NetBout is an isolated place for online communications. Alex is talking separately with Jessica, 105 and 107, and at the same time with Victor, 106 and 109.

Even though Jessica takes participation in two NetBouts at the same time, 107 and 108, Victor doesn't know about it.

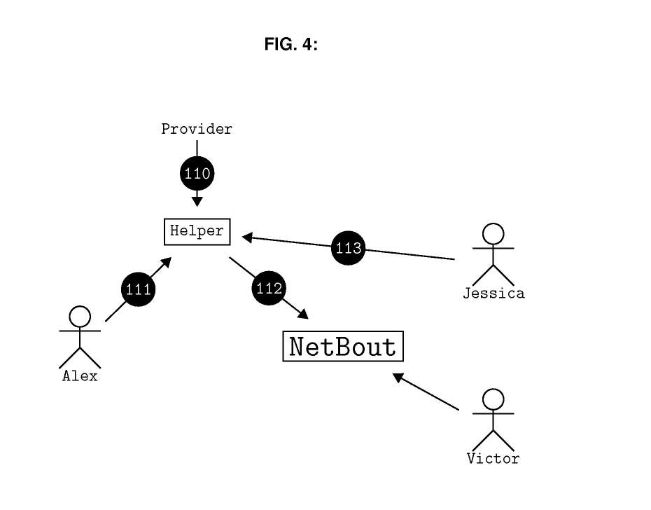

NetBout may be equipped with middleware software instruments (“helpers”) that facilitate interaction between people, as explained in FIG. 4. A good example of such a helper could be a video conferencing software/hardware system. Alex 111 and Jessica 113 talk to each other through RTSP/H.264 video conferencing. Helper facilitates the video conversation and protocols it to the NetBout 112.

As soon as the conversation is over, the Helper is released and can be detached from the NetBout.

The Helper may be provided in “software as a service” (SaaS), developed and supported by some third party company 110. In such a case, interaction between the Helper and NetBout can be established over the network 112. The NetBout platform acts as a mediator between users and Helper providers. Providers deliver their services through Helpers, designed and developed in a unified way to be convenient for end-users.

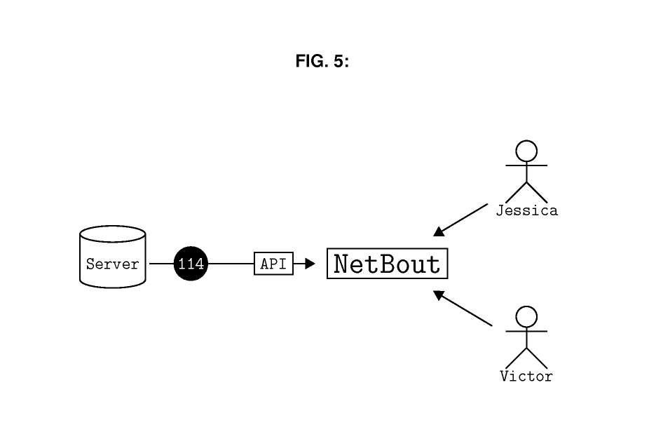

NetBout participants may be human beings or computers acting through an application programming interface (API), as explained in FIG. 5. The Server interacts with NetBout via the network, using API 114. In some cases, other NetBout participants may be unaware that one of them is a computer software with some artificial intelligence inside.

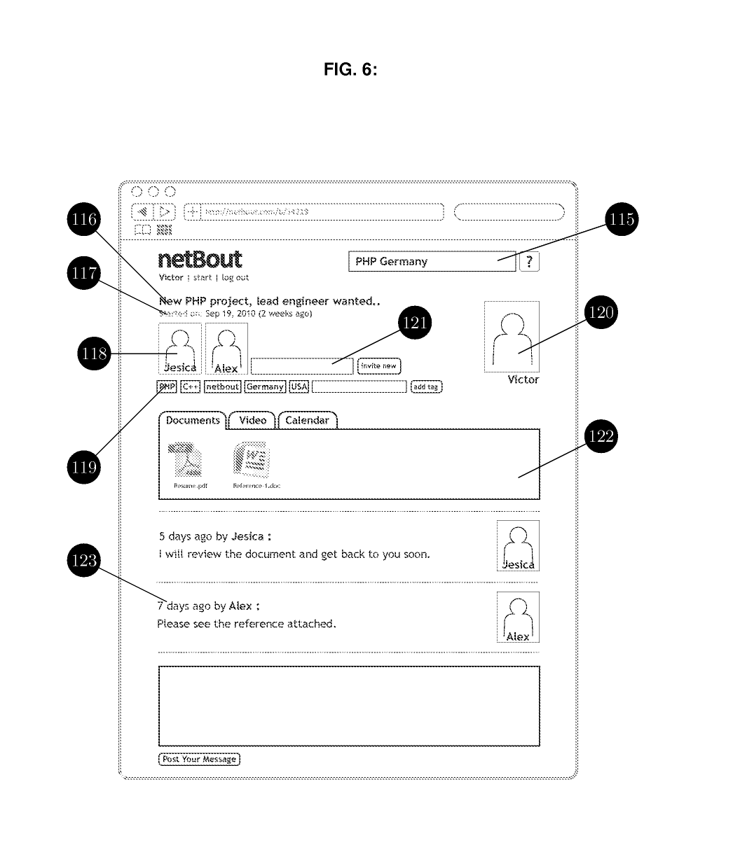

FIG. 6 demonstrates a layout of elements on a main web page of the NetBout system (available at www.netbout.com). There is an open conversation between three people: Alex, Victor and Jessica. They are talking about the potential hiring of Alex by Jessica. The conversation is organized by Victor, who is a recruiting manager in Jessica's company. We see the web page on behalf of Victor. It is important to remember that every participant of the NetBout has its own view of the conversation.

There is a subject of the conversation at 116, which is set by Victor. There is a date when this conversation was started, at 117. Both elements could be hidden in AJAX mode to give more space on the page for conversation elements, like images and messages.

Victor sees himself on the right side of the page at 120, his avatar (small personalized photo), and his NetBout unique ID. For every conversation, a user may select any particular identity to use. In other words, a user may masquerade himself from one conversation to another.

With 121 Victor can add more participants to the conversation. He just needs to start typing a name, or e-mail address, or any part of previous conversation with this person. The system will immediately find a list of the most suitable candidates (according to the entered part of text), and shows them in a drop-down list. Victor will select the desired one. If there is no such person on the list (meaning that Victor didn't talk with him before), Victor has the ability to add him. Victor continues to type in the e-mail and clicks “Invite”. The system automatically creates a new user account and sends an invitation to him. As soon as the new user approves the invitation, he gets added to the conversation.

There is a list of NetBout participants at 118, with their avatars and names. The list contains everybody who currently has access to the NetBout. Those who just received an invitation but have not yet confirmed (or rejected), are marked with a light gray background to indicate their unconfirmed status.

The NetBout has a number of tags, which are at 119. Victor attached those tags in order to categorize the NetBout and make it easily found amongst others. Victor can add new tags or remove existing tags. Other NetBout participants don't see which tags are attached by Victor. Tags in their behavior resemble mail boxes in Outlook or Gmail.

The NetBout “stage” at 122 is a virtual sub-environment rented by a third-party helper to manipulate the information exchange between participants. In this particular case the stage is labeled as “Documents” and is dedicated to online sharing of electronic documents (files). There are two files shared by Alex, and they are visible and downloadable by Victor and may be other participants (if Alex permitted).

Interaction between NetBout participants and stages is bi-directional, meaning that both a participant and a stage can initiate an interaction. For example, a “Calendar” stage may initiate a reminder call to some participants according to pre-defined list of events (e.g., an online meeting coming soon).

The last and the most important part is a chronologically sorted list of messages posted by NetBout participants, at 123. Every message has some “rich text” (text with embedded hyper links, images, sound, video fragments, simple formatting, etc.), an author (with its avatar and name), and a date when it was posted. Victor can sort messages and filter by certain criteria.

In order to switch to another conversation, Victor has to use the big search box on top of the page, at 115. He has to enter a name of participant, a quote from another NetBout conversation, or any other information. The system finds the most relevant NetBouts and lets Victor choose which one to render next so he can join the conversation.

### U.S. Patent Documents

The following US patents were found by the applicant:

| | | | |
|---|---|---|---|
| 5,907,677 | May 1999 | Glenn et al. | Method for establishing anonymous |
| | | | communication links |
| 6,209,100 | May 2001 | Robertson et al. | Moderated forums with anonymous but |
| | | | traceable contributions |
| 6,336,133 | January 2002 | Morris et al. | Regulating users of online forums |
| 6,393,461 | May 2002 | Okada et al. | Communication management system for a |
| | | | chat system |
| 6,400,381 | June 2002 | Barrett et al. | Web places |
| 6,405,197 | June 2002 | Gilmour | Method of constructing and displaying an |
| | | | entity profile constructed . . . |
| 6,434,599 | August 2002 | Porter | Method and apparatus for on-line chatting |
| 6,480,885 | November 2002 | Olivier | Dynamically matching users for group |
| | | | communications based on a threshold . . . |
| 6,496,851 | December 2002 | Morris et al. | Managing negotiations between users of a |
| | | | computer network by automatically . . . |
| 6,539,421 | March 2003 | Appelman et al. | Messaging application user interface |
| 6,608,888 | August 2003 | Bedingfield et al. | Methods and systems to provide a message |
| | | | in a messaging system without . . . |
| 6,611,822 | August 2003 | Beams et al. | System method and article of manufacture |
| | | | for creating collaborative . . . |
| 6,691,159 | February 2004 | Grewal et al. | Web-based method and system for |
| | | | providing assistance to computer users |
| 6,941,345 | September 2005 | Kapil et al. | Real-time, text-based messaging between |
| | | | devices in plural communities |
| 7,089,278 | August 2006 | Churchill et al. | Anchored conversations: adhesive, |
| | | | in-context, virtual discussion forums |
| 7,120,668 | October 2006 | Manber et al. | Systems and methods for matching |
| | | | participants to a conversation |
| 7,177,904 | February 2007 | Mathur et al. | Techniques for sharing content information |
| | | | with members of a virtual user . . . |
| 7,305,436 | December 2007 | Willis | User collaboration through discussion |
| | | | forums |
| 7,305,444 | December 2007 | Raguseo | Method and system for controlling delivery |
| | | | of information in a forum |
| 7,310,658 | December 2007 | Giles et al. | Method for tracking responses to a forum |
| | | | topic |
| 7,599,994 | October 2009 | Paik et al. | System and method for emailing and |
| | | | chatting |
| 7,797,274 | September 2010 | Strathearn et al. | Online content collaboration model |

The following US patent applications were found by the applicant:

| | | | |
|---|---|---|---|
| 12/259,254 | October 2008 | Wang et al. | Sharing Digital Content On A Social |
| | | | Network |

1. A method and software for data interchange between parties that includes:
1. creating an isolated private persistent data environment (NetBout);
2. adding and removing parties to said NetBout;
3. writing data to said NetBout;
4. reading data from said NetBout;
5. categorizing said NetBout for further processing.

2. The method and software according to claim 1, wherein the “isolation” means inability of any interactions and data interchanges between NetBouts.

3. The method and software according to claim 1, wherein the “privacy” means that data written to the NetBout is available for reading only for the parties added to the NetBout.

4. The method and software according to claim 1, wherein the “persistence” means that the NetBout cannot be deleted even by its parties.

5. The method and software according to claim 1, wherein the “party” is at least one of a human being, a human being behind computerized interface, a software, a Software As A Service (SaaS) component, a hardware, an other entity with digital or analog outputs or inputs.

6. The method and software according to claim 1, wherein the “data” is at least one of a text, a video stream, a audio stream, an electronic document, an image, a non-categorized electronic information, an other type of information.

7. The method and software according to claim 1, wherein the “NetBout” is at least one of a data structure in computer database, a number of files on a server in the network, a web service, a web resource, an other electronic data structure electronically accessible over one of network protocols.
